(19) United States
(12) Patent Application Publication
(10) Pub. No.: US 2010/0206674 A1
(43) Pub. Date: Aug. 19, 2010

(54) Disc Brake Rotors with Tilted Vane Geometry

(75) Inventors: Patrick J. Monsere, Highland, MI (US); Mark T. Riefe, Brighton, MI (US); David B. Antanaitis, Northville, MI (US); Brent D. Lowe, Milford, MI (US)

Correspondence Address: Keefe and Associates, 24405 Gratiot Avenue, Eastpointe, MI, 48021, US

(73) Assignee: GM GLOBAL TECHNOLOGY OPERATIONS, INC., Detroit, MI (US)

(21) Appl. No.: 12/371,704

(22) Filed: Feb. 16, 2009

(51) Int. Cl. F16D 65/12

(52) U.S. Cl. 188/218 XL

(57) ABSTRACT

A tilted vane brake rotor. The tilted vanes are tilted in the sense of being oriented with respect to the inside disc surfaces at other than 90 degrees, defined by an acute intersection angle with respect to either of the inside disc surfaces. The tilted vanes may be, for example, paired and oriented serially around the circumference of the rotor discs so as to provide a series of vane pairs in the form of: a series of alternately inverted V-shapes, a series of same oriented V-shapes, or a series of X-shapes.

### TECHNICAL FIELD

The present invention relates, in general, to vehicle disc brake systems and in particular to the rotor components thereof. More particularly, the present invention relates to tilted vane disc brake rotors.

### BACKGROUND OF THE INVENTION

Motor vehicle disc brake systems utilize, at each wheel, a brake rotor connected to an axle hub of a rotatable axle of the motor vehicle, and an opposing set of selectively movable brake pads connected to a non-rotating brake caliper which carries a set of brake pads. The brake rotor includes opposing brake pad engagement surfaces, or rotor cheeks, wherein when braking is to occur, the braking system causes the caliper to press the brake pads upon respective brake pad engagement surfaces of the rotor cheek. Frictional interaction between the rotating rotor cheeks and non-rotating brake pads causes braking of the motor vehicle to transpire, the rate of braking depending upon the pressure of the brake pads against the rotor cheeks.

In the automotive art, modern hydraulic braking systems typically include an operator or driver interface, such as a brake pedal. As the driver applies force to this pedal, this force is transmitted by means of control arms and other related devices to the master cylinder. The master cylinder accepts mechanical force as an input and produces hydraulic pressure, in the form of pressurized brake fluid, as an output. This pressure is conveyed by means of pressurized brake fluid through lines and valves of the motor vehicle to interface with each brake corner, found at each wheel of the motor vehicle.

FIG. 1 schematically depicts a brake corner 10, known in the art, configured for the usage of a sliding caliper (i.e., a piston at one side of the caliper). A brake line 12 conveys hydraulic brake fluid into the brake corner 10. This permits the application of force from the master cylinder (not shown) through pressurization of the hydraulic brake fluid, thereby creating a means of hydraulic control of the hydraulically active components of the brake caliper 20. The hydraulic brake fluid passes into a caliper actuator cylinder 22 and makes contact with a caliper actuator piston 24. The inboard side of the brake caliper 20a is hydraulically active in a sliding caliper configuration, whereas the outboard side of the brake caliper 20b is hydraulically inactive. A brake pad 32a, 32b, is respectively affixed at each side of the brake caliper 20, so that when the hydraulic brake fluid in the brake line 12 supplying the brake corner 10 is pressurized, the brake caliper 20 causes the brake pads to squeeze upon the rotor friction surfaces (i.e., rotor cheeks) 30a, 30b of the brake rotor 30, thereby inducing braking of the vehicle. The rotor cheeks 30a, 30b are each located on a respective outside surface of the rotor discs 34a, 34b, mutually separated by vanes 36 affixed to the inside surfaces of the rotor discs 34a, 34b.

Turning now to FIG. 2, an example of the conventional brake rotor 30 is shown. The rotor discs 34a and 34b each have, respectively an inside disc surface (opposite the corresponding rotor cheek) 38a, 38b, which form the margins for a cooling region 40 between the rotor discs. Vanes 36 are narrow strips of metal which populate the cooling region 40 and are attached at each end to the inside disc surfaces 38a, 38b at vane affixments 36a, 36b, whereby the vanes serve to connect together the rotor discs. The vanes 36 are evenly distributed in a manner which preserves a constant radial separation between mutually adjacent vanes. Each vane 36 is perpendicular (i.e., normally oriented) with respect to the inside disc surfaces 38a, 38b, wherein the intersection angle α_{C} is 90 degrees. Further, each vane 36 has a length L_{C}, a width W_{C}, a mutual vane spacing of S_{C}, and generally extends across the radius R_{C} of the rotor discs 34a, 34b.

In the normal course of the operation of a conventional brake system, the forces applied by the brake pads 32a and 32b to the rotor cheeks 30a, 30b of the brake rotor 30 can generate significant heating. This heating is undesirable, as the resulting elevated temperature can result in non-uniform thermal gradients across the brake rotor which, in turn, can result in thermal distortions of the brake rotor 30 and the brake pads 32a and 32b. At the very least, these distortions promote more rapid brake component wear and thereby higher maintenance costs. As a result, much effort has been expended to create brake rotors which have been designed in a fashion to facilitate the management of elevated brake rotor temperature. Elevated brake rotor temperature management is a complex dynamic, wherein design changes can impact both the heating rate and the cooling rate of the brake rotor.

Management of elevated brake rotor temperature, well known in the art, is by use of vented brake rotors, wherein the vanes 36 serve to hold the rotor discs together, yet keep open the cooling region 40 therebetween for the purpose of delivery of elevated heat of the brake rotor to the atmosphere. In this regard, heat is generated due to the interaction of the rotor cheeks 30a, 30b with the brake pads 32a, 32b, and flows conductively to the inside disc surfaces 38a, 38b, and further to the vanes 36, whereupon heat is dissipated in the cooling region 40 by convective heat transfer to the air circulating between the vanes. Thus, the flow of heat out through the cooling region 40 while yet maintaining stability and strength of the vanes 36 are the critical aspects of the design of a brake rotor.

In the prior art, innovations have been developed to enhance air flow between the vanes, as for example vane shapes which are intended to facilitate speeding up of the rate of air flow through the cooling region between the rotor discs.

In the overall design of brake rotors, if too much material is removed from the brake rotor, then the heating rate of the brake rotor may increase because of the lower heat capacity of the rotor discs and the brake rotor may not be durable enough to function long-term dependably in repeated braking processes without distortion. Further, the design of brake rotors needs to include considerations of optimal thermal dissipation characteristics and meet driver expectations for brake feel.

Historically, engineering of the human interface with a braking system has been a subjective endeavor. With the advent of a Brake Feel Index (BFI) as reported in SAE technical paper 940331 “Objective Characterization of Vehicle Brake Feel” (1994), a method was developed to correlate objective engineering parameters to these subjective assessments. In the case of BFI, such aspects as pedal application force, pedal travel and pedal preload are compared to desired target values which correlate to a particular type of response desired and the deviation from these target values is reflected in a lower index value. In disc brake systems, some of the causes of undesirable brake pedal feel have been related to noise and vibration.

The noise and vibration characteristics of a conventional brake rotor can be studied using the technique of normal coordinate analysis, well known in the art. This type of analysis indicates that brake rotors of the conventional type (i.e., shown at FIGS. 1 and 2), in which the vanes are oriented perpendicular to the inside disc surfaces, hereinafter referred to as “perpendicular vanes”, have three types of vibrational modes: compression modes caused by relative motions of the rotor discs towards each other, node diametrical modes caused by the coupling of local modes in each of the rotor discs, and racking modes, which are the most complex, caused by relative motion with respect to the central axis of rotation of one rotor disc relative to the other. Of these vibrational modes, the racking mode tends to be the loudest as perceived by the driver. FIGS. 3 and 4 are displacement profiles 50, 60, respectively of a typical racking mode vibration 52 and a typical node diametrical mode 62, respectively, of a prior art perpendicular vane rotor, as shown at FIG. 2. A detailed discussion of these profiles in comparison with the present invention will be presented hereinbelow.

The art has attempted to mitigate some of these rotor vibration problems. Swept vanes (see for example U.S. Pat. No. 6,119,820) and pillar-post vanes (see for example U.S. Pat. Nos. 6,405,839 and 6,454,058) have been attempted which could mitigate the noise issues. But, these types of perpendicular vanes can interfere with the flow of air through the cooling region. Increasing the perpendicular vane cross-sectional width and/or providing large pillars at the outer periphery (i.e., rotor outer diameter) will enhance the conductive heat transfer from the rotor discs to the perpendicular vanes and serve to increase rigidity of the brake rotor structure, but such perpendicular vanes will limit air flow through the cooling region and thereby limit convective heat transfer to the air and will also add weight to the vehicle and thereby lower mileage.

Accordingly, what remains needed in the art is a means to reduce the rotor noise level during braking without negatively impacting the thermal properties of the conventional rotor or the mileage of the vehicle.

### SUMMARY OF THE INVENTION

The present invention is a brake rotor vane configuration which reduces the rotor noise level due to braking without negatively impacting the thermal properties (as per a conventional rotor) or the mileage of the vehicle.

In contradistinction to the perpendicular vanes of conventional brake rotors, the brake rotors of the present invention utilize tilted vanes, in the sense that the vanes are oriented with respect to the inside disc surfaces at other than 90 degrees, defined by an acute intersection angle with respect to either of the inside disc surfaces (of course, being equivalently defined by the opposite obtuse angle with respect to the inside disc surface). The tilted vanes according to the present invention may be, for example, paired and oriented serially around the circumference of the rotor discs so as to provide a series of vane pairs in the form of: a series of alternately inverted V-shapes, a series of same oriented V-shapes, or a series of X-shapes.

One purpose of the tilted vanes is to increase the connection stiffness between the two (i.e., first and second) rotor discs, thereby increasing the frequency of the racking mode vibrations so that their frequency will be outside the normal human hearing range. This effect occurs because the tilted vanes of the present invention serve to counteract the compression due to frictional forces, rather than simply bend as the conventional perpendicular vanes would do. Also the tilting disrupts the node diametrical mode, while additionally increasing the frequencies.

Another purpose of the tilted vanes is to provide excellent heat management and structural stability. By increasing the tilted vane height (length), the thickness of the tilted vanes can be reduced and yet provide stability of the brake rotor. Conductive heat transfer to the tilted vanes from the rotor discs is excellent, and since the air circulation between the tilted vanes is kept free, the convective heat transfer from the tilted vanes to the atmosphere is also excellent.

This and additional objects, features and advantages of the present invention will become clearer from the following specification of a preferred embodiment.

### BRIEF DESCRIPTION OF THE DRAWINGS

FIG. 1 is a cross-sectional view of a prior art disc brake system employing a sliding caliper configuration.

FIG. 2 is a perspective end view of the prior art brake rotor of FIG. 1, having perpendicular vanes disposed between the first and second rotor discs thereof.

FIG. 3 is a displacement profile of a prior art brake rotor in a racking vibration mode.

FIG. 4 is a displacement profile of a prior art brake rotor in a node diametric vibration mode.

FIG. 5 is a perspective end view of a brake rotor according to the present invention having tilted vanes disposed between the first and second rotor discs thereof, shown in the form of a series of vane pairs, the vane pairs being of alternately inverted V-shapes.

FIG. 5A is a broken-away detailed side view, seen at circle 5A of FIG. 5.

FIG. 5B is a cross-sectional view, seen parallel to the rotor disks along line 5B-5B of FIG. 5.

FIG. 6A is a broken-away detailed side view, seen similar to FIG. 5A, of a brake rotor according to the present invention having tilted vanes in the form of a series of vane pairs, the vane pairs being of same oriented V-shapes.

FIG. 6B is a cross-sectional view, similar to FIG. 5B, of the brake rotor of FIG. 6A, seen along line 6B-6B in FIG. 6A.

FIG. 7A is a broken-away detailed side view, seen similar to FIG. 5A, of a brake rotor according to the present invention having tilted vanes in the form of a series of vane pairs, the vane pairs being of X-shapes.

FIG. 7B is a cross-sectional view, similar to FIG. 5B, of the brake rotor of FIG. 7A, seen along line 7B-7B in FIG. 7A.

FIG. 8 is a displacement profile of a tilted vane brake rotor according to the present invention as shown in FIGS. 5 through 5B, in a node diametric vibration mode.

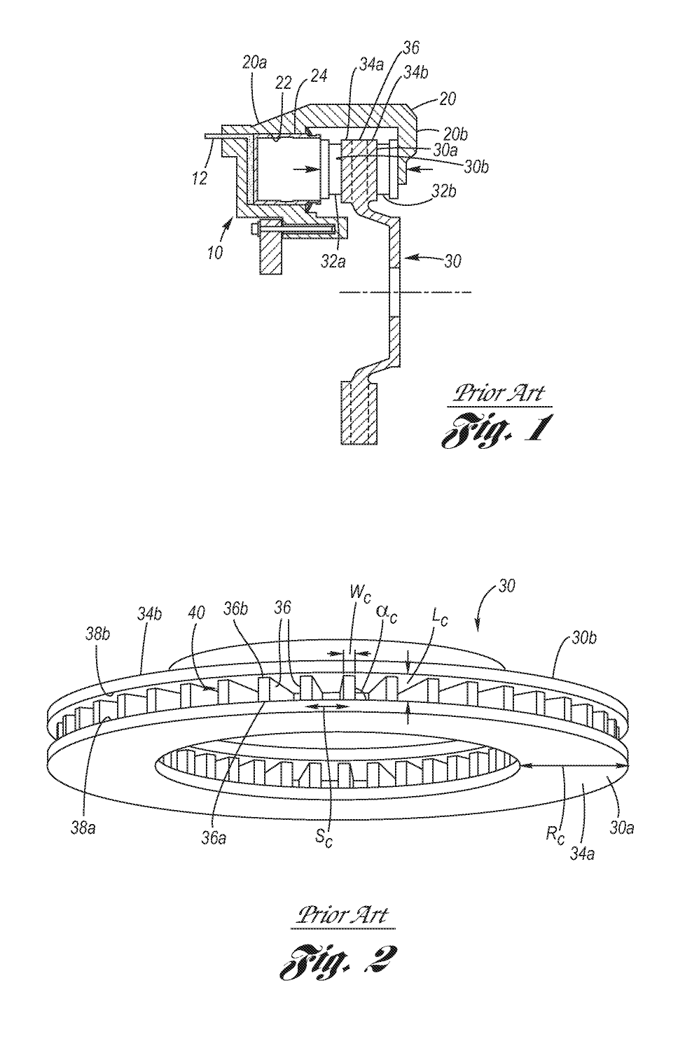

### DESCRIPTION OF THE PREFERRED EMBODIMENT

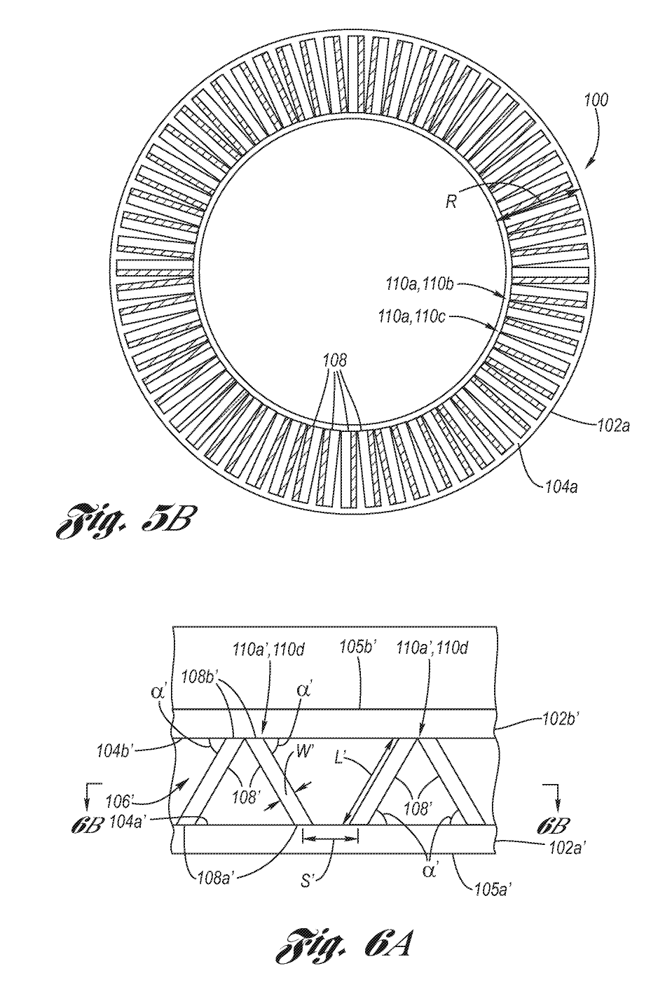

Referring now to the Drawing, FIGS. 5 through 8 depict various aspects of tilted vane brake rotors for disc brake systems according to the present invention which serve to reduce the audible noise produced in the course of operation of the braking system. The following description of the preferred embodiment is merely exemplary in nature and is not intended to limit the invention, its applications, or its uses.

Turning attention firstly to FIGS. 5 through 5B, a tilted vane brake rotor 100 according to the present invention is depicted. The rotor discs 102a and 102b (either of which being designatable as a first rotor disc and a second rotor disc) each have, respectively, an inside disc surface 104a, 104b (opposite the corresponding rotor cheek 105a, 105b), which form the margins for a cooling region 106 between the rotor discs. Tilted vanes 108 are narrow strips of metal which populate the cooling region 106 and are attached at each end to the inside disc surfaces 104a, 104b at vane affixments 108a, 108b, whereby the tilted vanes serve to connect together the rotor discs 102a, 102b. The tilted vanes 108 are distributed in a manner which preserves a serially repeating pattern of radial separation of the tilted vanes.

Each tilted vane 108 is “tilted” in the sense that the tilted vanes are oriented with respect to the inside disc surfaces 104a, 104b at other than 90 degrees, defined by an acute intersection angle α with respect to either of the inside disc surfaces (of course, being equivalently defined by the opposite obtuse angle with respect to the inside disc surface). The tilted vanes 108 are, in this example, grouped into vane pairs 110a which are oriented serially around the circumference of the rotor discs 104a, 104b so as to provide a series of vane pairs in the form of a series of alternately inverted V-shapes 110b, 110c. Each tilted vane 108 has a height (length) L, a width W, a mutual spacing S, and generally extends across the radius R of the rotor discs 104a, 104b.

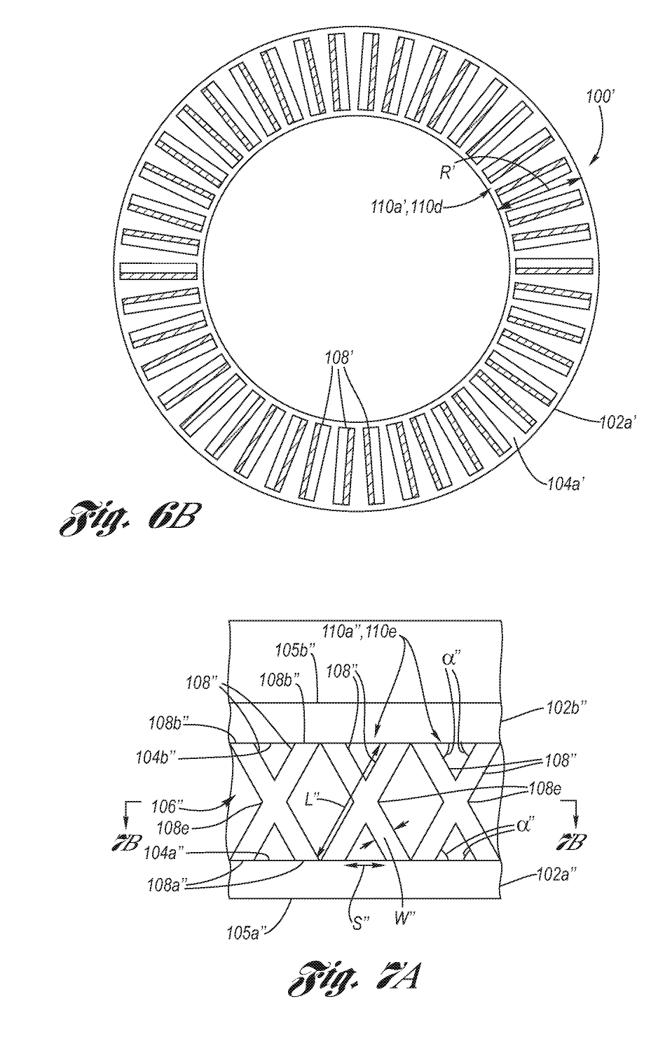

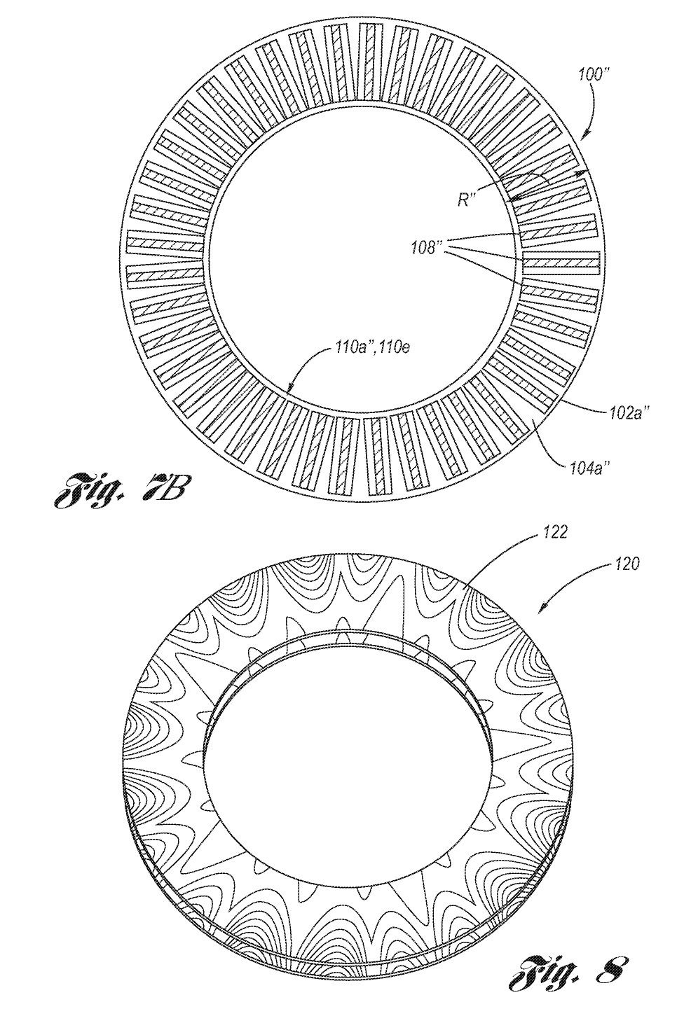

Turning attention now to FIGS. 6A through 7B other configurations for the tilted vanes of tilted vane brake rotors according to the present invention will be discussed, it being understood that, in a broadest sense, all that is sufficient is that the brake rotor have tilted vanes.

At FIGS. 6A and 6B, a tilted vane brake rotor 100′ according to the present invention is depicted. The rotor discs 102a′ and 102b′ (either of which being designatable as a first rotor disc and a second rotor disc) each have, respectively, an inside disc surface 104a′, 104b′ (opposite the corresponding rotor cheek 105a′, 105b′), which form the margins for a cooling region 106′ between the rotor discs. Tilted vanes 108′ are narrow strips of metal which populate the cooling region 106′ and are attached at each end to the inside disc surfaces 104a′, 104b′ at vane affixments 108a′, 108b′, whereby the tilted vanes serve to connect together the rotor discs 102a′, 102b′. The tilted vanes 108′ are distributed in a manner which preserves a serially repeating pattern of radial separation of the tilted vanes.

Each tilted vane 108′ is “tilted” in the sense that the tilted vanes are oriented with respect to the inside disc surfaces 104a′, 104b′ at other than 90 degrees, defined by an acute intersection angle α′ with respect to either of the inside disc surfaces (of course, being equivalently defined by the opposite obtuse angle with respect to the inside disc surface). The tilted vanes 108′ are, in this example, grouped into vane pairs 110a′ which are oriented serially around the circumference of the rotor discs 104a′, 104b′ so as to provide a series of vane pairs in the form of a series of same oriented V-shapes 110d. Each tilted vane 108′ has a height (length) L′, a width W′, a mutual vane spacing S′, and generally extends across the radius R′ of the rotor discs 104a′, 104b′.

At FIGS. 7A and 7B, a tilted vane brake rotor 100″ according to the present invention is depicted. The rotor discs 102a″ and 102b″ (either of which being designatable as a first rotor disc and a second rotor disc) each have, respectively, an inside disc surface 104a″, 104b″ (opposite the corresponding rotor cheek 105a″, 105b″), which form the margins for a cooling region 106″ between the rotor discs. Tilted vanes 108″ are narrow strips of metal which populate the cooling region 106″ and are attached at each end to the inside disc surfaces 104a″, 104b″ at vane affixments 108a″, 108b″, whereby the tilted vanes serve to connect together the rotor discs 102a″, 102b″. The tilted vanes 108″ are distributed in a manner which preserves a serially repeating pattern of radial separation of the tilted vanes.

Each tilted vane 108″ is “tilted” in the sense that the tilted vanes are oriented with respect to the inside disc surfaces 104a″, 104b″ at other than 90 degrees, defined by an acute intersection angle α ″ with respect to either of the inside disc surfaces (of course, being equivalently defined by the opposite obtuse angle with respect to the inside disc surface). The tilted vanes 108″ are, in this example, grouped into vane pairs 110a″ which are oriented serially around the circumference of the rotor discs 104a″, 104b″ so as to provide a series of vane pairs in the form of a series of X-shapes 110e. Each tilted vane 108″ has a height (length) L″, a width W″, a mutual vane spacing S″, and generally extends across the radius R″ of the rotor discs 104a″, 104b″.

By way of exemplification the tilted vanes 108, 108′, 108″ have, respectively, an acute intersection angle α, α′, α″ ranging from about 80 degrees to about 36 degrees, and preferably by way of example of about 58 degrees.

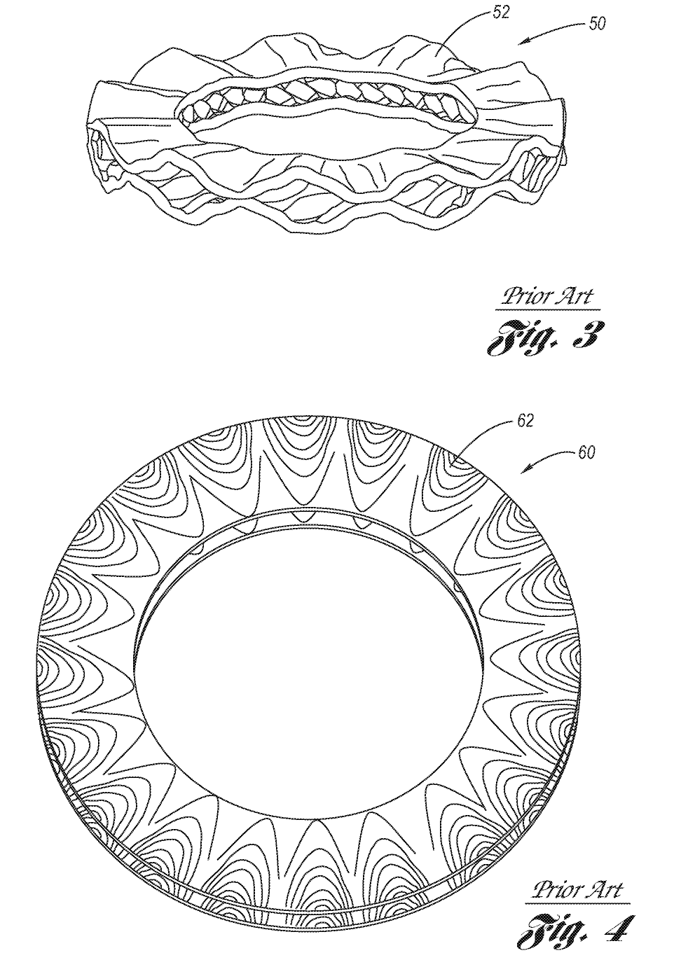

A brief functional comparison of the conventional perpendicular brake rotor with respect to the tilted vane brake rotor of the present invention is as follows. In FIG. 2, the vane affixments 36a, 36b of the perpendicular vanes 36 for the conventional perpendicular vane brake rotor 30 are directly opposed, which configuration aligns the forces between the two rotor discs so that the forces on the perpendicular vanes are localized into direct opposition. This vane affixment disposition facilitates bending of the perpendicular vanes. Whereas, in FIGS. 5 through 7B, the vane affixments 108a, 108a′, 108a″, 108b, 108b′, 108b″ of the tilted vanes 108, 108′, 108″ for the respective tilted vane rotors 100, 100′, 100″ are distributed and staggered so that the forces on the vanes are not opposingly localized. Further, in the X-shape 110e of FIGS. 7A and 7B, the crossing point of the vanes 108″ of each vane pair 110a″ also forms a point of attachment 108e.

### Example I

This example is a comparison between a tilted vane brake rotor according to the present invention, and a perpendicular vane brake rotor of the prior art, being presented herein merely by way of exemplar illustration and not limitation.

The tilted vane disc rotor according to the present invention, similar to that of FIG. 5, has a mass of 7.7 kg, has a 296 mm diameter, has 7.5 mm thick rotor discs, and has a mutual vane spacing of 13 mm between the inside disc surfaces. The tilted vanes have a width of 4.9 mm, the vane spacing is 20.9 mm and the acute interface angle is 58 degrees. There is a total of 60 tilted vanes.

The conventional perpendicular vane brake rotor, similar to that of FIG. 2, has a mass of 7.58 kg, has a 296 mm diameter, has 7.5 mm thick rotor discs, and has a mutual vane spacing of 13 mm between the inside disc surfaces. The perpendicular vanes have a width of 6 mm, the vane spacing is 22 mm and the interface angle is 90 degrees. There is a total of 41 perpendicular vanes.

The following observations were made. The tilted vanes have a surface area about 12% larger than the perpendicular vanes. The tilted vane rotor effectively increased the frequency of the racking mode from 11 kHz over that of the perpendicular vane brake rotor to a frequency beyond human hearing (above about 18 kHz, possibly above about 22 kHz). The nodal diametrical modes were not clearly defined for the tilted vane brake rotor and were approximately 6% higher in frequency over the perpendicular vane brake rotor. Further, the V-shape of the tilted vane pairs allows counteraction of frictional forces in compression/tension, as opposed to pure bending as with conventional perpendicular vanes, and leads to a 10% increase in stiffness.

As discussed hereinabove, the normal coordinate analysis shows that brake rotors have three types of vibrational modes, namely node diametrical, compression, and racking. Table I shows the results of a normal coordinate analysis calculation of the normal modes of the conventional perpendicular vane brake rotor versus the tilted vane brake rotor, both of Example I.

In this example, “Mode #” refers to the vibration type and order; “Perpendicular Vane” refers to the convention perpendicular vane rotor (FIG. 2); “Tilted Vane” refers to the tilted vane rotor of the present invention (FIGS. 5 through 5B); “Stiffness Increase” refers to the percentage stiffness increase of the tilted vane rotor over that of the conventional perpendicular vane rotor; “Description” is explanatory of “Mode #”.

TABLE I
Free-Free Normal Modes Analysis

| | Perpendicular Vane | Tilted Vane | Stiffness Increase | |
|---|---|---|---|---|
| Mode # | (Hz) | (Hz) | (for tilted vanes, %) | Description |
| 2 ND | 742 | 787 | 6.06 | 2nd Nodal Diametrical |
| 3 ND | 1871 | 2020 | 7.96 | 3rd Nodal Diametrical |
| 4 ND | 3114 | 3407 | 9.41 | 4th Nodal Diametrical |
| 5 ND | 4393 | 4829 | 9.92 | 5th Nodal Diametrical |
| 6 ND | 5696 | 6239 | 9.53 | 6th Nodal Diametrical |
| 7 ND | 7022 | 7616 | 8.46 | 7th Nodal Diametrical |
| 8 ND | 8374 | 8948 | 6.85 | 8th Nodal Diametrical |
| 9 ND | 9756 | 10220 | 4.76 | 9th Nodal Diametrical |
| 10 ND | 11160 | 11440 | 2.51 | 10th Nodal Diametrical |
| 11 ND | 12600 | 12550 | −0.40 | 11th Nodal Diametrical |
| 12 ND | 14080 | 13550 | −3.76 | 12th Nodal Diametrical |
| 1 C | 6117 | 6062 | −0.90 | 1st Compressional |
| 2 C | 9353 | 9454 | 1.08 | 2nd Compressional |
| 3 C | 13020 | 13190 | 1.31 | 3rd Compressional |
| 1 R | 12610 | — | N/A | 1st Racking |
| 2 R | 13420 | — | N/A | 2nd Racking |

As can be seen from Table I, the frequency shifts higher with the tilted vane brake rotor configured as depicted at FIGS. 5 through 5B for the lower frequency node diametrical mode, but drops for the higher frequency node diametrical mode and the compression mode. In the case of the node diametrical mode, the alignment of the vane attachment points in the prior art perpendicular vane brake rotor facilitate the correlation of the local vibration modes between the two rotor discs.

This effect can be seen clearly when comparing the displacement profiles of the node diametrical mode. The alignment of the vane affixments of the perpendicular vanes in the prior art brake rotor serves to facilitate the coupling of the local vibration modes in the brake rotor discs. In the present invention, the vane affixments of the tilted vanes are not aligned directly opposite of their counterpart on the opposing inside disc surfaces, thereby not facilitating the correlation between the local vibration modes within each rotor disc.

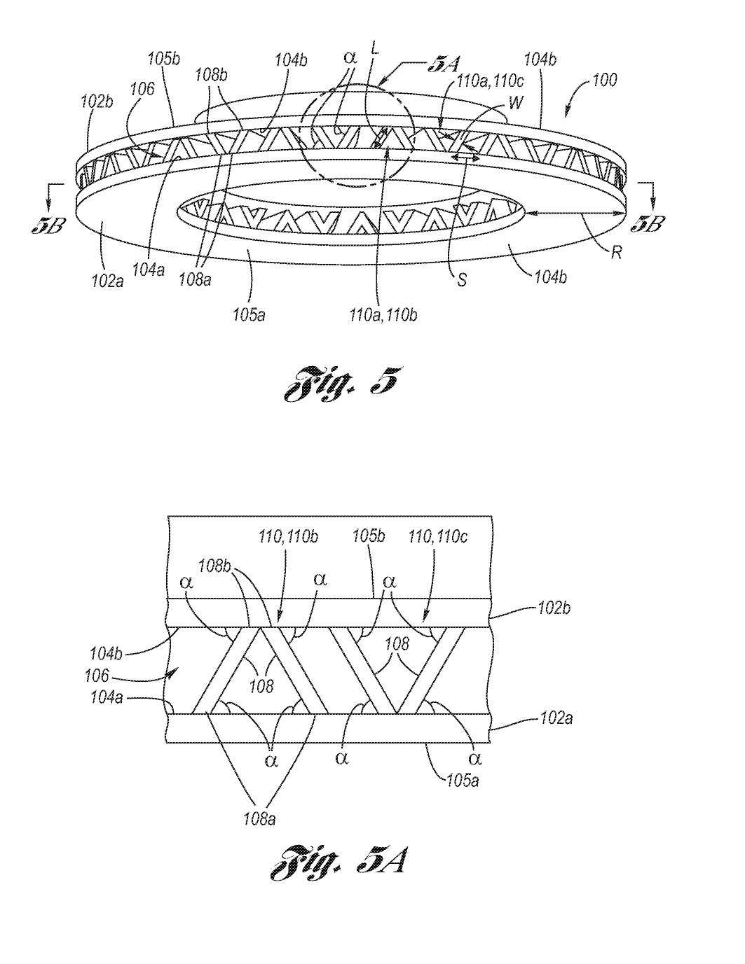

Table I is profiled in FIGS. 3, 4 and 8, wherein the racking mode results are not shown for the tilted vane brake rotor, because the frequency of these modes are shifted out of the audible range. The structure of the displacement profile for the racking mode of the tilted vane brake rotor is similar to that of the displacement profile for the racking mode of the prior art perpendicular vane brake rotor, as seen in FIG. 3. FIG. 4, as previously mentioned, shows an enhanced vibrational displacement profile 60 of the conventional perpendicular vane brake rotor. In contradistinction, FIG. 8 shows a muted, disorganized vibrational displacement profile 120 of the node diametrical mode 122 of the tilted vane brake rotor configured, as shown at FIGS. 5 through 5B.

All of the versions of the tilted vane rotors (i.e., FIGS. 5 through 7B) according to the present invention add to the stiffness of the tilted vanes due to the relatively distributed locations of the vane affixments. This stiffness contributes to the off-diagonal elements of the surface stress tensor of each rotor disc. These off-diagonal components produce forces perpendicular to the force applied to the rotor discs by the brake pads, thereby producing displacements within the plane of the rotor discs. The effect of these displacements is that the intensity of the racking mode of vibration is enhanced, thereby causing an increase in the frequency of the racking modes, elevating them out of the human audible frequency range.

To those skilled in the art to which this invention appertains, the above described preferred embodiments may be subject to change or modification. Such change or modification can be carried out without departing from the scope of the invention, which is intended to be limited only by the scope of the appended claims.

1. A disc brake rotor, comprising:
a first rotor disc having a first rotor cheek and a first inside disc surface;
a second rotor disc having a second rotor cheek and a second inside disc surface, said first and second inside disc surfaces being mutually superposed and separated therebetween by a cooling region; and
a plurality of tilted vanes being disposed in said cooling region, each tilted vane being affixed at one end to said first inside disc surface and at the other end to said second inside disc surface;
wherein each tilted vane is oriented relative to said first and second inside disc surfaces at other than 90 degrees.

2. The disc brake rotor of claim 1, wherein said plurality of tilted vanes comprise a plurality of vane pairs, each vane pair forming a V-shape.

3. The disc brake rotor of claim 2, wherein said plurality of vane pairs comprise a series of same oriented V-shapes.

4. The disc brake rotor of claim 2, wherein said plurality of vane pairs comprise a series of alternately inverted V-shapes.

5. The disc brake rotor of claim 1, wherein said plurality of tilted vanes comprise a plurality of vane pairs, each vane pair forming an X-shape.

6. The disc brake rotor of claim 1, wherein each said tilted vane is disposed at an acute intersection angle with respect to either of said first and second inside surfaces.

7. The disc brake rotor of claim 6, wherein said acute intersection angle ranges between about 80 degrees and about 36 degrees.

8. The disc brake rotor of claim 7, wherein said plurality of tilted vanes comprise a plurality of vane pairs, each vane pair forming a V-shape.

9. The disc brake rotor of claim 8, wherein said acute intersection angle is about 58 degrees.

10. The disc brake rotor of claim 8, wherein said plurality of vane pairs comprise a series of same oriented V-shapes.

11. The disc brake rotor of claim 10, wherein said acute intersection angle is about 58 degrees.

12. The disc brake rotor of claim 8, wherein said plurality of vane pairs comprise a series of alternately inverted V-shapes.

13. The disc brake rotor of claim 12, wherein said acute intersection angle is about 58 degrees.

14. The disc brake rotor of claim 7, wherein said plurality of tilted vanes comprise a plurality of vane pairs, each vane pair forming an X-shape.

15. The disc brake rotor of claim 14, wherein said acute intersection angle is about 58 degrees.

16. A disc brake rotor, comprising:
a first rotor disc having a first rotor cheek and a first inside disc surface;
a second rotor disc having a second rotor cheek and a second inside disc surface, said first and second inside disc surfaces being mutually superposed and separated therebetween by a cooling region; and
a plurality of tilted vanes being disposed in said cooling region, each tilted vane being affixed at one end to said first inside disc surface and at the other end to said second inside disc surface;
wherein each said tilted vane is disposed at an acute intersection angle with respect to either of said first and second inside surfaces; and
wherein said acute intersection angle ranges between about 80 degrees and about 36 degrees.

17. The disc brake rotor of claim 16, wherein said plurality of tilted vanes comprise a plurality of vane pairs, each vane pair forming a V-shape.

18. The disc brake rotor of claim 17, wherein said plurality of vane pairs comprise a series of same oriented V-shapes.

19. The disc brake rotor of claim 17, wherein said plurality of vane pairs comprise a series of alternately inverted V-shapes.

20. The disc brake rotor of claim 16, wherein said plurality of tilted vanes comprise a plurality of vane pairs, each vane pair forming an X-shape.
